(19) United States
(12) Patent Application Publication
(10) Pub. No.: US 2023/0222406 A1
(43) Pub. Date: Jul. 13, 2023

(54) UTILIZING OPTIMIZATION SOLVER MODELS FOR SEQUENTIAL AUTOMATED WORKFORCE SCHEDULING

(71) Applicant: Accenture Global Solutions Limited, Dublin (IE)

(72) Inventors: Vijay DESAI, San Diego, CA (US); Ravi F. PRAKASH, Bangalore (IN); Sahil GOVEL, Delhi (IN); Rohit KUMAR, Barhauna (IN)

(21) Appl. No.: 17/571,041

(22) Filed: Jan. 7, 2022

(51) Int. Cl. G06Q 10/06

(52) U.S. Cl. CPC G06Q 10/063112; G06Q 10/063116

(57) ABSTRACT

A device may receive a request for a schedule and scheduling constraints to utilize when generating the schedule, and may process, based on the request, a first portion of the scheduling constraints and first optimization variables, with a first optimization solver model, to generate capacity data for the schedule. The device may process the capacity data, a second portion of the scheduling constraints, and second optimization variables, with a second optimization solver model, to generate shift assignment data for the schedule, and may process the shift assignment data, a third portion of the scheduling constraints, and third optimization variables, with a third optimization solver model, to generate skill and task assignment data for the schedule. The device may generate the schedule based on the capacity data, the shift assignment data, and the skill and task assignment data, and may perform one or more actions based on the schedule.

### BACKGROUND

Workforce scheduling is a process of establishing schedules of workers to meet current and future demands in a workplace, such as a restaurant, a hospital, a retail store, a call center, and/or the like. Workforce scheduling also involves defining schedules so that a transition from one shift to another shift is seamless and work remains uninterrupted. In an industry that relies on hourly workers, workforce scheduling forms a foundation of smooth business functioning.

### SUMMARY

Some implementations described herein relate to a method. The method may include receiving a request for a schedule and scheduling constraints to utilize when generating the schedule, and processing, based on the request, a first portion of the scheduling constraints and first optimization variables, with a first optimization solver model, to generate capacity data for the schedule. The method may include processing the capacity data, a second portion of the scheduling constraints, and second optimization variables, with a second optimization solver model, to generate shift assignment data for the schedule, and processing the shift assignment data, a third portion of the scheduling constraints, and third optimization variables, with a third optimization solver model, to generate skill and task assignment data for the schedule. The method may include generating the schedule based on the capacity data, the shift assignment data, and the skill and task assignment data, and performing one or more actions based on the schedule.

Some implementations described herein relate to a device. The device may include one or more memories and one or more processors coupled to the one or more memories. The one or more processors may be configured to receive a request for a schedule and scheduling constraints to utilize when generating the schedule, and process, based on the request, a first portion of the scheduling constraints and first optimization variables, with a first constraint programming model, to generate capacity data for the schedule. The one or more processors may be configured to process the capacity data, a second portion of the scheduling constraints, and second optimization variables, with a second constraint programming model, to generate shift assignment data for the schedule, and process the shift assignment data, a third portion of the scheduling constraints, and third optimization variables, with a third constraint programming model, to generate skill and task assignment data for the schedule. The one or more processors may be configured to generate the schedule based on the capacity data, the shift assignment data, and the skill and task assignment data, and perform one or more actions based on the schedule.

Some implementations described herein relate to a non-transitory computer-readable medium that stores a set of instructions for a device. The set of instructions, when executed by one or more processors of the device, may cause the device to receive a request for a schedule and scheduling constraints to utilize when generating the schedule. The scheduling constraints may include demand constraints, operation hours constraints, shift timing constraints, days off pattern constraints, schedule rotation constraints, employee roster constraints, and/or employee restriction constraints. The set of instructions, when executed by one or more processors of the device, may cause the device to process, based on the request, a first portion of the scheduling constraints and first optimization variables, with a first optimization solver model, to generate capacity data for the schedule, and process the capacity data, a second portion of the scheduling constraints, and second optimization variables, with a second optimization solver model, to generate shift assignment data for the schedule. The set of instructions, when executed by one or more processors of the device, may cause the device to process the shift assignment data, a third portion of the scheduling constraints, and third optimization variables, with a third optimization solver model, to generate skill and task assignment data for the schedule, and generate the schedule based on the capacity data, the shift assignment data, and the skill and task assignment data. The set of instructions, when executed by one or more processors of the device, may cause the device to perform one or more actions based on the schedule.

### BRIEF DESCRIPTION OF THE DRAWINGS

FIGS. 1A-1F are diagrams of an example implementation described herein.

FIGS. 2A and 2B are diagrams illustrating an example of using optimization solver models in connection with sequential automated workforce scheduling.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing optimization solver models for sequential automated workforce scheduling.

### DETAILED DESCRIPTION

The following detailed description of example implementations refers to the accompanying drawings. The same reference numbers in different drawings may identify the same or similar elements.

Workforce scheduling is the backbone of many business operations. For example, a business may employ a computer-implemented scheduler to perform workforce scheduling within a portion of or across an entire organization. A scheduler must plan for enough capacity to ensure that no demand (e.g., every thirty minutes for four through twelve weeks) goes unmet and that there is no waste of manpower. A scheduler must also ensure that the correct skills of employees are utilized to meet dynamic demand, that shifts are defined to mirror demand distribution, that a buffer is maintained to handle vacation and/or breaks, that a schedule complies with labor laws, that there is uniform and proportionate distribution of over and under capacity, and/or the like. Current workforce scheduling systems may fail to handle over and under scheduling, unfair scheduling, employee vacation and leave planning, shift swapping, conformance with labor laws, task allocation across intervals for multi-skilled employees, and/or the like. Furthermore, current workforce scheduling systems require an inordinate quantity of resources and may require a couple of days or weeks to generate an acceptable schedule for large organizations.

Therefore, current workforce scheduling systems consume computing resources (e.g., processing resources, memory resources, communication resources, and/or the like), networking resources, and/or the like associated with requiring an inordinate quantity of time to generate an acceptable schedule for large organizations, generating unacceptable schedules that fail to handle over and under scheduling, unfair scheduling, employee vacation and leave planning, shift swapping, conformance with labor laws, task allocation across intervals for multi-skilled employees, and/or the like.

Some implementations described herein relate to a scheduling system that utilizes optimization solver models for sequential automated workforce scheduling. Optimization solver models may improve decision-making around planning, allocating, and scheduling scarce computing resources by embedding powerful models that can solve programming models, constraint programming, and constraint-based scheduling models. For example, the scheduling system may receive a request for a schedule and scheduling constraints to utilize when generating the schedule, and may process, based on the request, a first portion of the scheduling constraints and first optimization variables, with a first optimization solver model, to generate capacity data for the schedule. The scheduling system may process the capacity data, a second portion of the scheduling constraints, and second optimization variables, with a second optimization solver model, to generate shift assignment data for the schedule, and may process the shift assignment data, a third portion of the scheduling constraints, and third optimization variables, with a third optimization solver model, to generate skill and task assignment data for the schedule. The scheduling system may generate the schedule based on the capacity data, the shift assignment data, and the skill and task assignment data, and may perform one or more actions based on the schedule.

In this way, the scheduling system utilizes optimization solver models for sequential automated workforce scheduling. The scheduling system may include a optimization solver model-based automated workforce scheduling system that creates and manages schedules more quickly (e.g., within thirty minutes for large organizations), experiences fewer scheduling errors, reduces deviations or infractions to safety and compliance regulations, provides employee fairness and flexibility, better utilizes cross-skilled resources, optimizes team size to meet demand, provides interval level schedule generation, provides greater employee engagement, and/or the like. The scheduling system may process scheduling constraints (e.g., demand, capacity, shift and/or break constraints, rotation constraints, labor laws, and vacation and/or holiday schedules), with a three-stage optimization engine, to generate an optimal and compliant schedule. This, in turn, conserves computing resources, networking resources, and/or the like that would otherwise have been consumed in requiring an inordinate quantity of time to generate an acceptable schedule for large organizations, generating unacceptable schedules that fail to handle over and under scheduling, unfair scheduling, employee vacation and leave planning, shift swapping, conformance with labor laws, task allocation across intervals for multi-skilled employees, and/or the like.

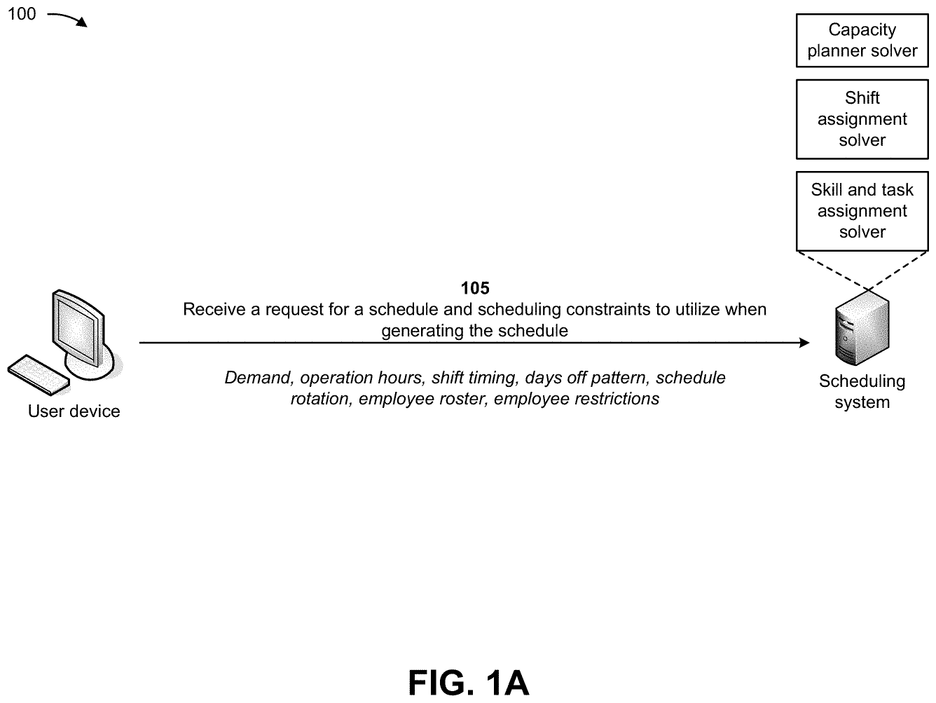

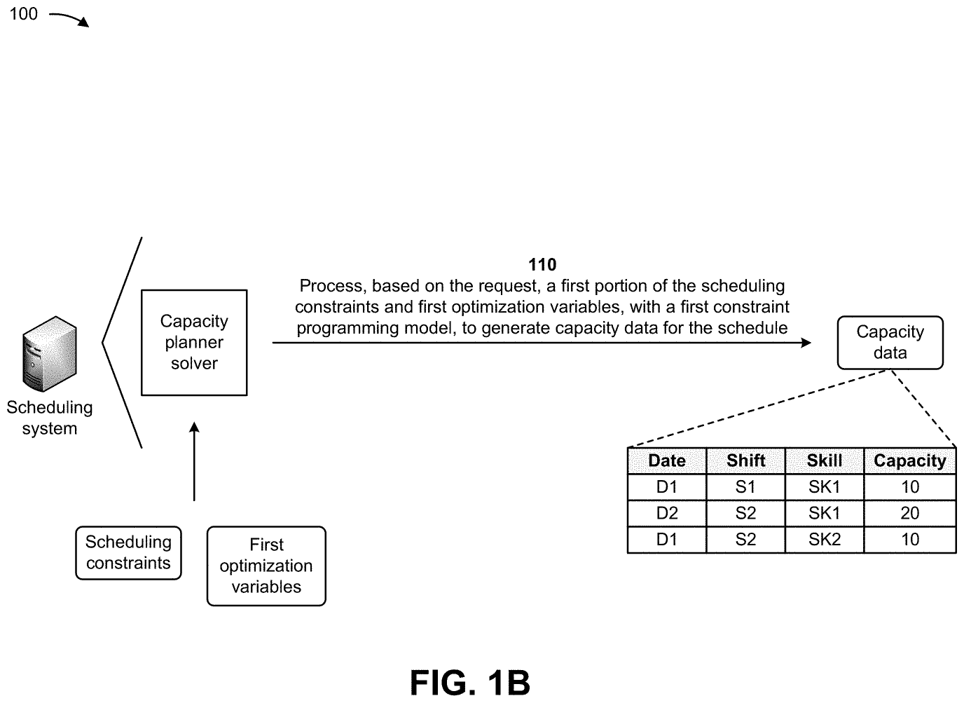

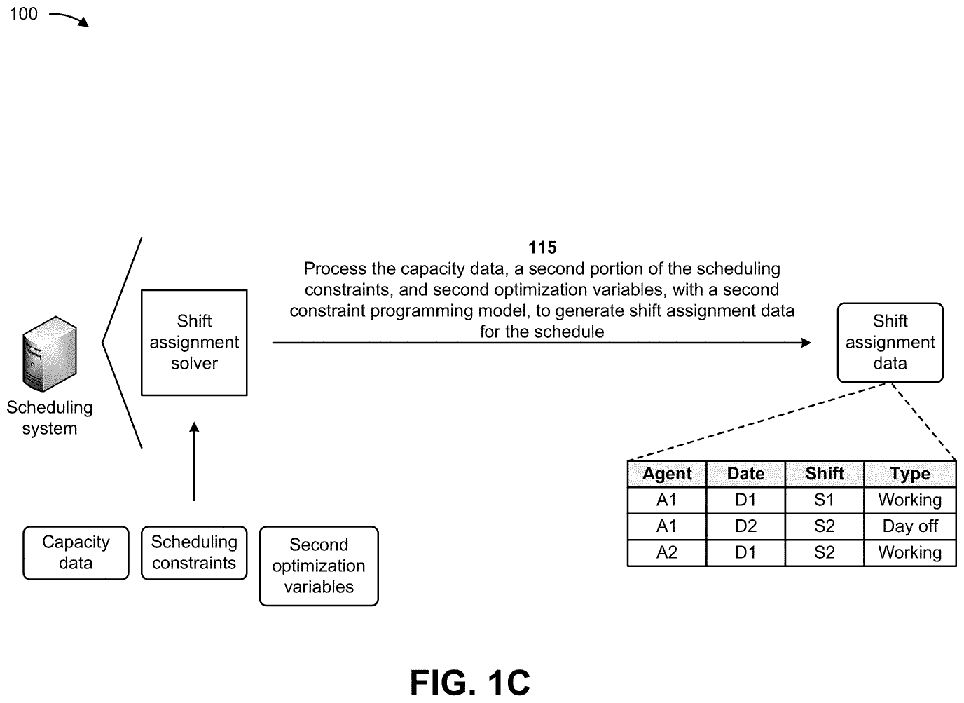

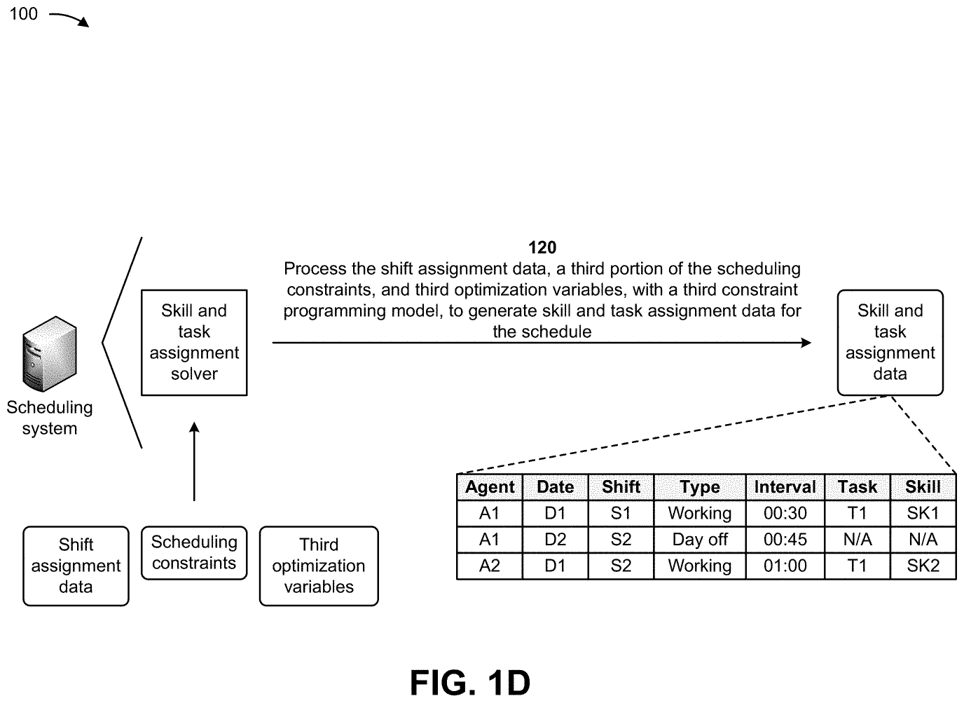

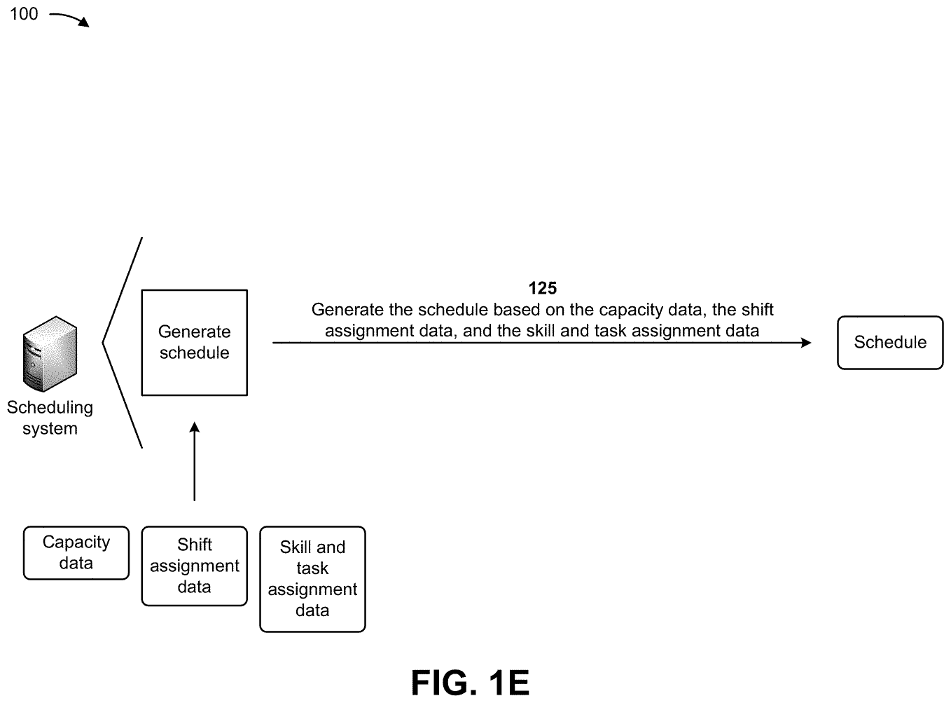

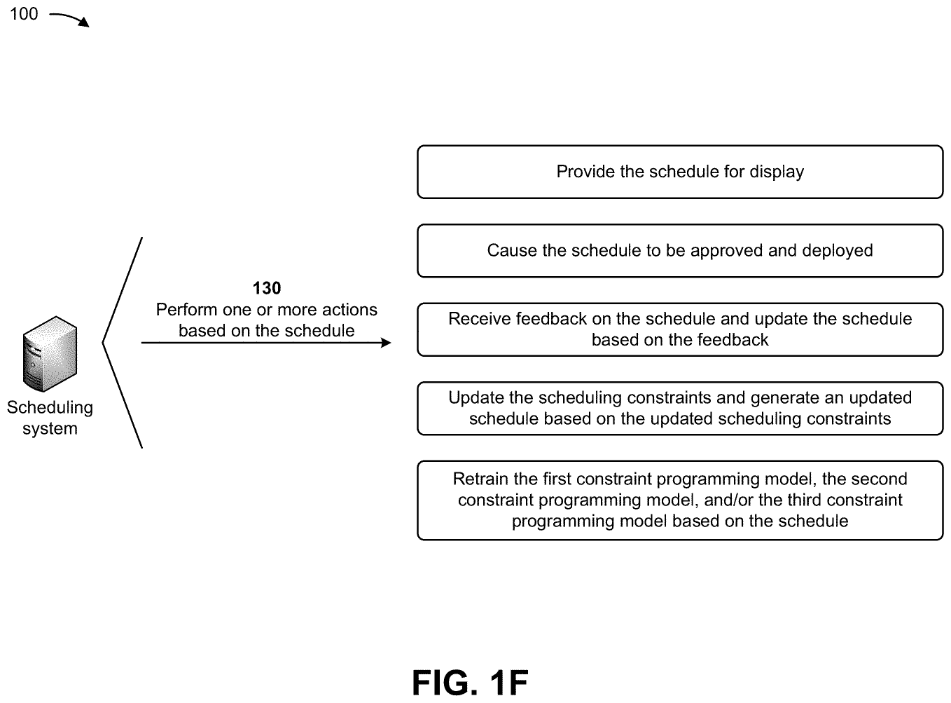

FIGS. 1A-1F are diagrams of an example 100 associated utilizing optimization solver models for sequential automated workforce scheduling. As shown in FIGS. 1A-1F, example 100 includes a user device associated with a scheduling system. The user device may include a wireless communication device, a mobile phone, a laptop computer, a tablet computer, a desktop computer, and/or the like. The scheduling system may include a system that utilizes optimization solver models for sequential automated workforce scheduling. Further details of the user device and the scheduling system are provided elsewhere herein.

As shown in FIG. 1A, the scheduling system may include a three-stage optimization engine that includes a capacity planner solver, a shift assignment solver, and a skill and task assignment solver. The three-stage optimization engine may produce an optimal and compliant schedule via the capacity planner solver, the shift assignment solver, and the skill and task assignment solver. The three-stage optimization engine may decompose a scheduling problem into three sequential stages where an output of each stage feeds into the next stage to generate a final schedule in a short period of time that cannot be achieved by current solutions. This decomposition decreases a complexity of the scheduling problem multi-fold, which enables determination of a feasible and optimal solution much faster with utilization of less computing resources as compared to current solutions. The capacity planner solver may plan capacity across shifts of the schedule to meet a demand associated with the schedule. The shift assignment solver may assign employees (e.g., also referred to as agents) to shifts to meet the planned capacity (e.g., generated by the capacity planner solver) and to ensure that employee constraints are satisfied. The skill and task assignment solver may plan breaks and tasks for each employee for each interval in an assigned shift. Further details of the capacity planner solver, the shift assignment solver, and the skill and task assignment solver are provided below in connection with FIGS. 1B-1D, respectively.

As further shown in FIG. 1A, and by reference number 105, the scheduling system may receive a request for a schedule and scheduling constraints to utilize when generating the schedule. For example, a user of the user device may cause the user device to provide the request for the schedule to the scheduling system, and the scheduling system may receive the schedule from the user device. In some implementations, the schedule may include a schedule for employees to work, a schedule with one or more shifts over a particular time period (e.g., four to twelve weeks), and/or the like. The schedule may include incremental time periods (e.g., intervals, such as thirty minute intervals) associated with each of the one or more shifts.

The scheduling system may receive the scheduling constraints from the user device or from another device (e.g., a server device) associated with an entity requesting the schedule. The scheduling constraints may include requirements to be satisfied when generating the schedule. For example, the scheduling constraints may include demand constraints (e.g., a group of employees, tasks associated with the employees, skills associated with the employees, and/or the like), operation hours constraints (e.g., different skills of the employees may follow different operation hours), shift timing constraints (e.g., a fixed start time, a flexible start time with guides for start and end times, and/or the like), days off pattern constraints (e.g., fixed days off, flexible days off with additional constraints on possible days off patterns, and/or the like), schedule rotation constraints (e.g., days off rotation, frequency of days off rotation, shift time rotation, and frequency of shift time rotation), employee roster constraints (e.g., work in any shift, work in a specific time range, requested specific days off, and/or the like), employee restriction constraints (e.g., multiple skills, and employees associated with different groups and/or teams), and/or the like. In some implementations, the scheduling system may store the scheduling constraints in a data structure (e.g., a database, a table, a list, and/or the like) associated with the scheduling system.

As shown in FIG. 1B, and by reference number 110, the scheduling system (e.g., the capacity planner solver) may process, based on the request, a first portion of the scheduling constraints and first optimization variables, with a first constraint programming model (e.g., a first optimization solver model), to generate capacity data for the schedule. In some implementations, the first portion of the scheduling constraints may include scheduling constraints associated with a variable (x_{i,j,k}) defining an agent (j) working on a skill (i) during a time period (k) and a variable (A_{i,j,k}) defining the agent (j) eligible to work on the skill (i) in the time period (k). For example, the first portion of the scheduling constraints may include the following scheduling constraints:
Σᵢx_{i,j,k}≤1; ∀_{j,k},
Σᵢx_{i,j,k}≤2*working hours; ∀ⱼ,
x_{i,j,k}≤A_{i,j,k}; ∀_{i,j,k},
Σᵢx_{i,j,k}≥min (maxCap, demand of period k, skill i),
Σᵢx_{i,j,k}=1 if agent j is working in shift starting from period k,
Σᵢx_{i,j,k}=1∀_{j,k} in 1st period for 1st agent of shift, and
Σᵢx_{i,j,k}≤1∀_{j,k} in 1st agent for all possible flex shifts.

In some implementations, the first optimization variables may include a variable (x_{i,j,k}) defining an agent (j) working on a skill (i) during a time period (k), a variable (A_{i,j,k}) defining the agent (j) eligible to work on the skill (i) in the time period (k), and/or the like. The first constraint programming model may iterate (e.g., over a particular time period) through the first portion of the scheduling constraints and the first optimization variables until a feasible solution is determined for the capacity data. In some implementations, the capacity data may be calculated according to the following equation:

Capacity data=MinimizeΣ_{i,j,k}x_{i,j,k}.

For example, the capacity data may include data identifying capacity requirements as per a demand for the schedule, whether a schedule shift definition is retraining capacity planning for the schedule, which skills are under the demand or over the demand for the schedule, and/or the like.

As further shown in FIG. 1B, the capacity data may include a table with a date field, a shift field, a skill field, and a capacity field. The date field may include multiple entries for dates (e.g., D1, D2, and/or the like) associated with the schedule. The shift field may include multiple entries for shifts (e.g., S1, S2, and/or the like) associated with the schedule. The skill field may include multiple entries for skills (e.g., SK1, SK2, and/or the like) associated with agents and the schedule. The capacity field may include multiple entries for capacity requirements (e.g., ten, twenty, and/or the like) as per the demand for the schedule.

As shown in FIG. 1C, and by reference number 115, the scheduling system (e.g., the shift assignment solver) may process the capacity data, a second portion of the scheduling constraints, and second optimization variables, with a second constraint programming model (e.g., a second optimization solver model), to generate shift assignment data for the schedule. In some implementations, the second portion of the scheduling constraints may include scheduling constraints associated with a variable (Aₐ) associated with an agent (a) assigned to a shift, a variable (P_{p,d}) associated with a day (d) working in a pattern identifier (p), a variable (AS_{a,sh}) associated with the agent (a) belonging to a shift (sh), a variable (AD_{a,d}) associated with a day type for the agent (a) on a day (d), a variable (AP_{a,p}) associated with the pattern identifier (p) assigned to the agent (a), a variable (ASS_{a,dt,sh,sks}) associated with the agent (a) assigned a skillset (sks) in the shift (sh) on a date (dt), a variable (ASK_{a,dt,sh,sks,sk}) associated with the agent (a) assigned a skill (sk) in the skillset (sks) in the shift (sh) on the date (dt), a variable (TS_{t,sh}) associated with a quantity of agents in a team (t) assigned to the shift (sh), a variable (SL_{dt,sh,sks,sk}) associated with a shortfall on the date (dt) in the shift (sh) for the skill (sk) in the skillset (sks), a variable (SL_{dt,sh,sks,sk}) associated with a square of the shortfall on the date (dt) in the shift (sh) for the skill (sk) in the skillset (sks), a variable (APH_{a,h,d}) associated with a working day for the agent (a) on the day (d) in a historical schedule (h), a variable (ASH_{a,h,sh}) associated the agent (a) assigned to the shift (sh) in the historical schedule (h), and/or the like.

For example, the second portion of the scheduling constraints may include the following scheduling constraints:
AS_{a,sh}=0 if agent a has no skill in shift sh,
ΣₛₕAS_{a,sh}=1, if distribute excess (e.g., allocate excess demand)=1,
ΣₛₕAS_{a,sh}≤1, if distribute excess=0,
ASK_{a,dt,sh,sks,sk}=0, if ASS_{a,dt,sh,sks}=0,
ΣₛₖASK_{a,dt,sh,sks,sk}>0, if ASS_{a,dt,sh,sks}=1,
AD_{a,d}=1, if AP_{a,p}=1 and P_{p,d}=1, else 0,
ΣₚAP_{a,p}=1, if distribute excess=1,
ΣₚAP_{a,p}=1, if distribute excess=0 and Aₐ=1,
ΣₚAP_{a,p}=0, if distribute excess=0 and Aₐ=0,
Σ_{d}AD_{a,d}=0, if Aₐ=0,
ASS_{a,dt,sh,sks}=0, if AS_{a,sh}=0,
ASS_{a,dt,sh,sks}=0, if agent a on leave, holiday, day off, or exclusion on date dt,
ΣₐASS_{a,dt,sh,sks}=0, if Aₐ=0 and distribute excess=1,
ΣₐASS_{a,dt,sh,sks}>0, if Aₐ=1 and distribute excess=1,
Aₐ=1, if AS_{a,sh}=1 and distribute excess=0,
Aₐ=0, if ΣₛₕAS_{a,sh}=0 and distribute excess=0,
TS_{t,sh}=Σ_{act}AS_{a,sh},
TS_{t,sh}=0 or count(act) if Grouping=mandatory,
AS_{a,sh}=0, if shift sh not in exemption list for agent a,
AS_{a,sh}=0, if agent a violates minimum shift gap constraint,
AS_{a,sh}=0, if agent a violates minimum/maximum consecutive days constraint,
ΣₛₖₛASS_{a,dt,sh,sks}≤1,
ΣₐASK_{a,dt,sh,sks,sk}+SL_{dt,sh,sks,sk}32 demand,
SLS_{dt,sh,sks,sk}=SL_{dt,sh,sks,sk}*SL_{dt,sh,sks,sh}.

In some implementations, the second optimization variables may include a variable (Aₐ) associated with an agent (a) assigned to a shift, a variable (P_{p,d}) associated with a day (d) working in a pattern identifier (p), a variable (AS_{a,sh}) associated with the agent (a) belonging to a shift (sh), a variable (AD_{a,d}) associated with a day type for the agent (a) on a day (d), a variable (AP_{a,p}) associated with the pattern identifier (p) assigned to the agent (a), a variable (ASS_{a,dt,sh,sks}) associated with the agent (a) assigned a skillset (sks) in the shift (sh) on a date (dt), a variable (ASK_{a,dt,sh,sks,sk}) associated with the agent (a) assigned a skill (sk) in the skillset (sks) in the shift (sh) on the date (dt), a variable (TS_{t,sh}) associated with a quantity of agents in a team (t) assigned to the shift (sh), a variable (SL_{dt,sh,sks,sk}) associated with a shortfall on the date (dt) in the shift (sh) for the skill (sk) in the skillset (sks), a variable (SL_{dt,sh,sks,sk}) associated with a square of the shortfall on the date (dt) in the shift (sh) for the skill (sk) in the skillset (sks), a variable (APH_{a,h,d}) associated with a working day for the agent (a) on the day (d) in a historical schedule (h), a variable (ASH_{a,h,sh}) associated the agent (a) assigned to the shift (sh) in the historical schedule (h), and/or the like. The second constraint programming model may iterate (e.g., over a particular time period) through the capacity data, the second portion of the scheduling constraints, and the second optimization variables until a feasible solution is determined for the shift assignment data. In some implementations, the shift assignment data may be calculated according to the following equations:
pattern=Σ_{a,h,d}(h*(1−APH_{a,h,d})*(1−AD_{a,d})),
shift=Σ_{a,h,sh}(h*ASH_{a,h,sh}*AS_{a,sh}),
demand=Σ_{dt,sh,sks,sk}(SLS_{dt,sh,sks,sk}),
team=Σₜ(max(TS_{t,sh})) if grouping=optional, else 0,
agent=Σₐ(Aₐ), and
Shift assignment data=pattern+(maxpattern*shift)+(maxpattern*maxshift*agent)+(maxpattern*maxshift*maxagent*maxteam*demand)+(maxpattern*maxshift*maxagent*maxdemand*team).
   For example, the shift assignment data may include data identifying issues due to agent restrictions for the schedule, whether vacation days are defined properly for the schedule, whether vacation date rotations constrain planning for one or more shifts of the schedule, and/or the like.

As further shown in FIG. 1C, the shift assignment data may include a table with an agent field, a date field, a shift field, and a type field. The agent field may include multiple entries for agents (e.g., A1, A2, and/or the like) associated with the schedule. The date field may include multiple entries for dates (e.g., D1, D2, and/or the like) associated with the schedule. The shift field may include multiple entries for shifts (e.g., S1, S2, and/or the like) associated with the schedule. The type field may include multiple entries for activities (e.g., working, day off, and/or the like) associated with the schedule.

As shown in FIG. 1D, and by reference number 120, the scheduling system (e.g., the skill and task assignment solver) may process the shift assignment data, a third portion of the scheduling constraints, and third optimization variables, with a third constraint programming model (e.g., a third optimization solver model), to generate skill and task assignment data for the schedule. In some implementations, the third portion of the scheduling constraints may include scheduling constraints associated with a variable (AS_{a,I,sk}) associated with an agent (a) working with a skill (sk) in an interval (i), a variable (SL_{i,sk}) associated with a shortfall in the interval (i) for the skill (sk), a variable (SLS_{dt,sk}) associated with a square of the shortfall on a date (dt) for the skill (sk), a variable (AS_{a,i,sk}=0) associated with the agent (a) being on leave, a holiday, a day off, or an exclusion in the interval (i), a variable (AA_{a,i,ac}=0) associated the activity (ac) not being allowed in the interval (i), and/or the like.

For example, the third portion of the scheduling constraints may include the following scheduling constraints:
Σ_{sk,ac}(AS_{a,i,sk}+AA_{a,i,ac})≤1,
ΣₐAA_{a,i,ac}≤maximum agents in the activity,
Σₐ(AS_{a,i,sk})+SL_{i,sk}=demand.

In some implementations, the third optimization variables may include a variable (AS_{a,I,sk}) associated with an agent (a) working with a skill (sk) in an interval (i), a variable (SL_{i,sk}) associated with a shortfall in the interval (i) for the skill (sk), a variable (SLS_{dt,sk}) associated with a square of the shortfall on a date (dt) for the skill (sk), a variable (AS_{a,i,sk}=0) associated with the agent (a) being on leave, a holiday, a day off, or an exclusion in the interval (i), a variable (AA_{a,i,ac}=0) associated the activity (ac) not being allowed in the interval (i), and/or the like. The third constraint programming model may iterate (e.g., over a particular time period) through the shift assignment data, the third portion of the scheduling constraints, and the third optimization variables until a feasible solution is determined for the skill and task assignment data. In some implementations, the skill and task assignment data may be calculated according to the following equation:

Skill and task assignment data=Σ_{i,sk}(SL_{i,sk}).

For example, the skill and task assignment data may include data identifying whether breaks are causing a shortfall during one or more time intervals, and/or the like.

As further shown in FIG. 1D, the skill and task assignment data may include a table with an agent field, a date field, a shift field, a type field, an interval field, a task field, and a skill field. The agent field may include multiple entries for agents (e.g., A1, A2, and/or the like) associated with the schedule. The date field may include multiple entries for dates (e.g., D1, D2, and/or the like) associated with the schedule. The shift field may include multiple entries for shifts (e.g., S1, S2, and/or the like) associated with the schedule. The type field may include multiple entries for activities (e.g., working, day off, and/or the like) associated with the schedule. The interval field may include multiple entries for time intervals (e.g., 00:30, 00:45, 01:00, and/or the like) associated with the schedule. The task field may include multiple entries for tasks (e.g., T1, not applicable (N/A), and/or the like) associated with the schedule. The skill field may include multiple entries for skills (e.g., SK1, N/A, SK2, and/or the like) associated with the schedule. In some implementations, the tables depicted in FIGS. 1B-1D may be grouped into a multi-dimensional matrix.

As shown in FIG. 1E, and by reference number 125, the scheduling system may generate the schedule based on the capacity data, the shift assignment data, and the skill and task assignment data. For example, the scheduling system may combine the capacity data, the shift assignment data, and the skill and task assignment data to generate the schedule. In some implementations, since the capacity data is utilized to generate the shift assignment data and the shift assignment data is utilized to generate the skill and task assignment data, the scheduling system may generate the schedule based solely on the skill and task assignment data. For example, the scheduling system may deem the skill and task assignment data to be the schedule since the skill and task assignment data incorporates the capacity data and the shift assignment data. In this way, the scheduling system may quickly (e.g., in minutes to an hour time) and easily generate a schedule that would require current systems days or weeks to generate.

In some implementations, the scheduling system may modify one or more of the scheduling constraints (e.g., for different scenarios) to generate one or more schedules based on the one or more scheduling constraints. The one or more schedules may include information identifying different shortfalls, different agents assigned to the different schedules, and/or the like. Such scenario building may enable the scheduling system to tune the scheduling constraints based on needs before executing actual automated scheduling to generate the final schedule. For example, the scheduling system may modify the quantity of shifts, shift timings, skills allowed in each shift, shift types (e.g., flexible or fixed), days off, types of days off (e.g., flexible or fixed), the quantity of agents, agent skill distribution, activity timing, activity type (e.g., fixed, flexible, maximum agents allowed, time limitations, and/or the like), duration, and/or the like.

In some implementations, the scheduling system may utilize autoscaling when utilizing the capacity planner solver, the shift assignment solver, and the skill and task assignment solver. For example, the scheduling system may temporarily allocate one or more first resources for generating the capacity data for the schedule (e.g., by the capacity planner solver), may temporarily allocate one or more second resources for generating the shift assignment data for the schedule (e.g., by the shift assignment solver), may temporarily allocate one or more third resources for generating the skill and task assignment data for the schedule (e.g., by the skill and task assignment solver), and/or the like). In some implementations, the scheduling system may temporarily add resources when resource (e.g., processor) usage is greater than a threshold usage (e.g., 70%, 80%, 90%, and/or the like).

As further shown in FIG. 1F, and by reference number 130, the scheduling system may perform one or more actions based on the schedule. In some implementations, performing the one or more actions includes the scheduling system providing the schedule for display. For example, the scheduling system may provide information identifying the schedule to the user device, and the user device may display the information identifying the schedule to a user of the user device. In this way, the scheduling system may conserve computing resources, networking resources, and/or the like that would otherwise have been consumed in requiring an inordinate quantity of time to generate an acceptable schedule for large organizations, generating unacceptable schedules that fail to handle over and under scheduling, unfair scheduling, employee vacation and leave planning, shift swapping, conformance with labor laws, task allocation across intervals for multi-skilled employees, and/or the like.

In some implementations, performing the one or more actions includes the scheduling system causing the schedule to be approved and deployed. For example, the scheduling system may provide the schedule the user device with a request to approve the schedule. A user of the user device may review and approve the schedule via the user device. The approval of the schedule may be provided to the scheduling system, and the scheduling system may cause the schedule to be deployed (e.g., via a scheduling system). In this way, the scheduling system may conserve computing resources, networking resources, and/or the like that would otherwise have been consumed in requiring an inordinate quantity of time to generate an acceptable schedule for large organizations, generating unacceptable schedules that fail to handle over and under scheduling, and/or the like.

In some implementations, performing the one or more actions includes the scheduling system receiving feedback on the schedule and updating the schedule based on the feedback. For example, the scheduling system may provide the schedule to the user device and a user may utilize the user device to review and provide the feedback on the schedule. The user device may provide the feedback to the scheduling system, and the scheduling system may update the schedule based on the feedback. In this way, the scheduling system may conserve computing resources, networking resources, and/or the like that would otherwise have been consumed in generating unacceptable schedules that fail to handle over and under scheduling, unfair scheduling, employee vacation and leave planning, shift swapping, conformance with labor laws, task allocation across intervals for multi-skilled employees, and/or the like.

In some implementations, performing the one or more actions includes the scheduling system updating the scheduling constraints and generating an updated schedule based on the updated scheduling constraints. For example, the scheduling system may modify one or more of the scheduling constraints (e.g., for different scenarios) and may generate one or more schedules based on the one or more modified scheduling constraints. In some implementations, the scheduling system may modify the quantity of shifts, shift timings, skills allowed in each shift, shift types, days off, types of days off, the quantity of agents, agent skill distribution, activity timing, activity type, duration, and/or the like. In this way, the scheduling system may conserve computing resources, networking resources, and/or the like that would otherwise have been consumed in requiring an inordinate quantity of time to generate an acceptable schedule for large organizations, generating unacceptable schedules that fail to handle over and under scheduling, unfair scheduling, and/or the like.

In some implementations, performing the one or more actions includes the scheduling system retraining the first constraint programming model, the second constraint programming model, and/or the third constraint programming model based on the schedule. For example, the scheduling system may utilize the schedule as additional training data for retraining the first constraint programming model, the second constraint programming model, and/or the third constraint programming model, thereby increasing the quantity of training data available for training the first constraint programming model, the second constraint programming model, and/or the third constraint programming model. Accordingly, the scheduling system may conserve computing resources associated with identifying, obtaining, and/or generating historical data for training the first constraint programming model, the second constraint programming model, and/or the third constraint programming model relative to other systems for identifying, obtaining, and/or generating historical data for training optimization solver models.

In this way, the scheduling system utilizes optimization solver models for sequential automated workforce scheduling. The scheduling system may include a optimization solver model-based automated workforce scheduling system that creates and manages schedules more quickly (e.g., within thirty minutes for large organizations), experiences fewer scheduling errors, reduces deviations or infractions to safety and compliance regulations, provides employee fairness and flexibility, better utilizes cross-skilled resources, optimizes team size to meet demand, provides interval level schedule generation, provides greater employee engagement, and/or the like. The scheduling system may process scheduling constraints (e.g., demand, capacity, shift and/or break constraints, rotation constraints, labor laws, and vacation and/or holiday schedules), with a three-stage optimization engine, to generate an optimal and compliant schedule. This, in turn, conserves computing resources, networking resources, and/or the like that would otherwise have been consumed in requiring an inordinate quantity of time to generate an acceptable schedule for large organizations, generating unacceptable schedules that fail to handle over and under scheduling, unfair scheduling, employee vacation and leave planning, shift swapping, conformance with labor laws, task allocation across intervals for multi-skilled employees, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

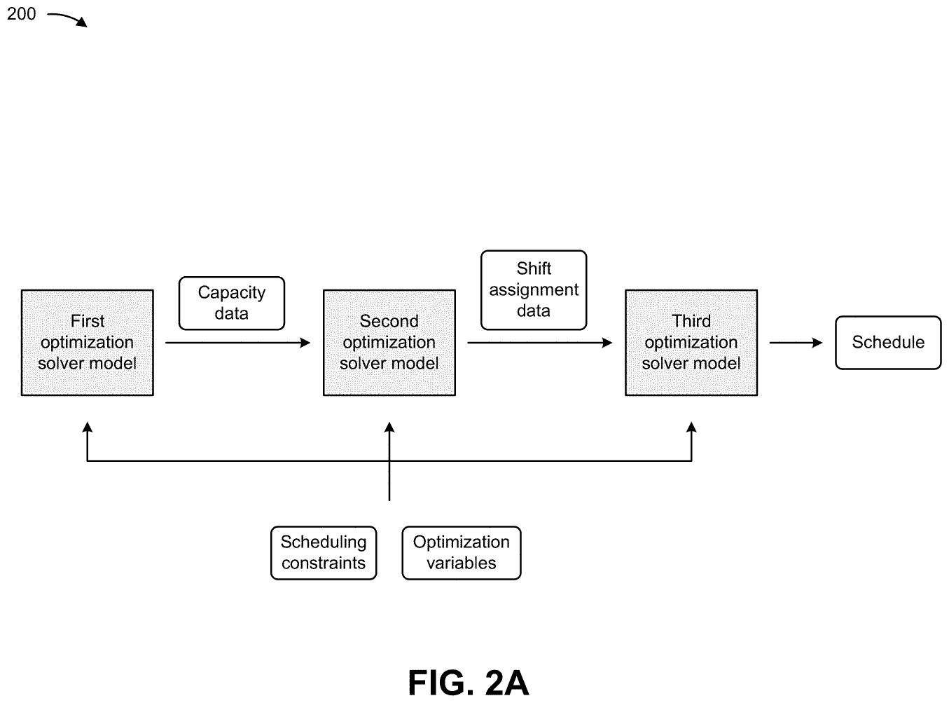

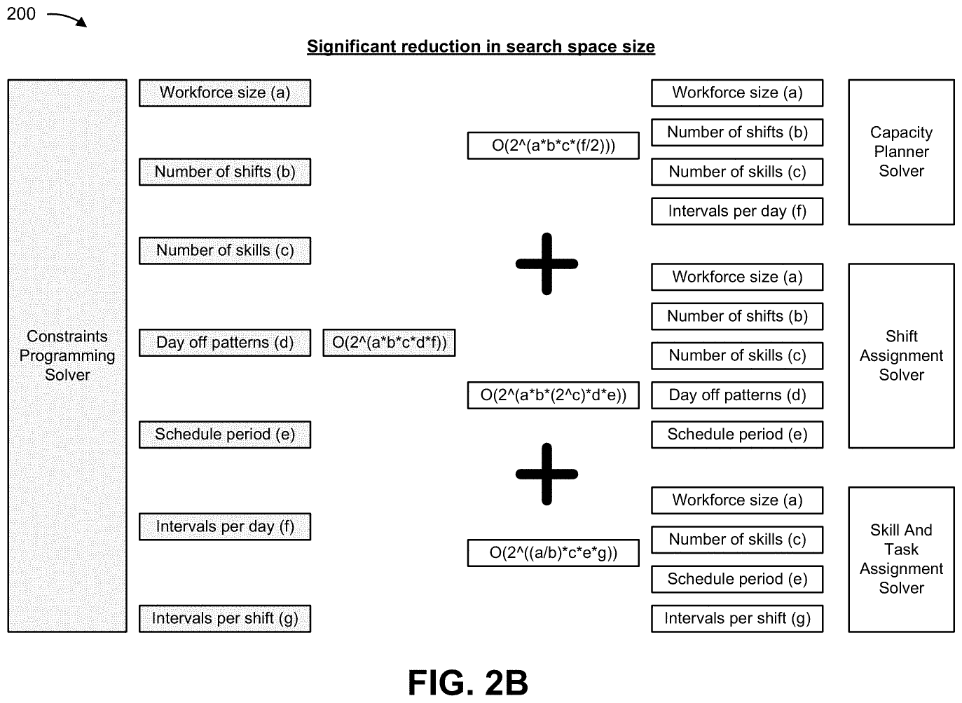

FIGS. 2A and 2B are diagrams illustrating an example 200 of using optimization solver models in connection with sequential automated workforce scheduling. As shown in FIG. 2A, the first optimization solver model may process the first portion of the scheduling constraints and the first optimization variables to generate the capacity data for the schedule. The second optimization solver model may receive the capacity data and may process the capacity data, the second portion of the scheduling constraints, and the second optimization variables to generate the shift assignment data for the schedule. The third optimization solver model may receive the shift assignment data and may process the shift assignment data, the third portion of the scheduling constraints, and the third optimization variables to generate the schedule. In this way, the scheduling system may process the scheduling constraints and the optimization variables in a three-stage optimization solver model process, to generate an optimal and compliant schedule.

FIG. 2B depicts a comparison between a current workforce scheduling system (e.g., a constraints programming solver) and the three-stage optimization engine described herein. As shown, the three-stage optimization engine may produce an optimal and compliant schedule via the capacity planner solver, the shift assignment solver, and the skill and task assignment solver, with a significant reduction in search space size as compared to the constraints programming solver. The three-stage optimization engine may decompose a scheduling problem into three sequential stages where an output of each stage feeds into the next stage to generate a final schedule in a short period of time that cannot be achieved by the constraints programming solver. This decomposition decreases a complexity of the scheduling problem multi-fold, which enables determination of a feasible and optimal solution much faster with utilization of less computing resources as compared to the constraints programming solver.

As indicated above, FIGS. 2A and 2B are provided as examples. Other examples may differ from what is described in connection with FIGS. 2A and 2B.

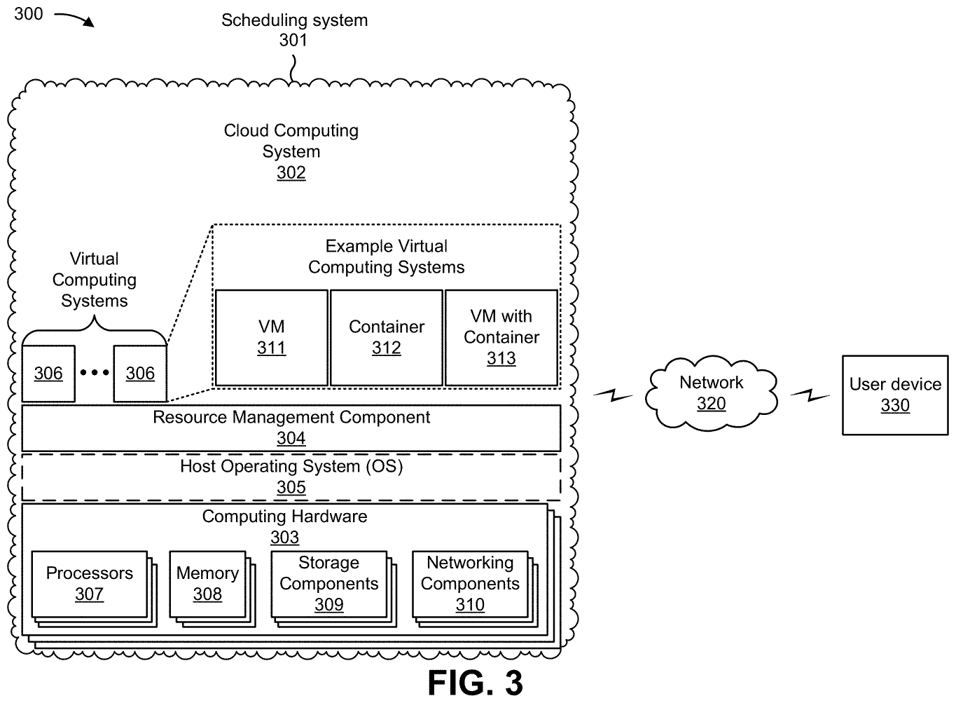

FIG. 3 is a diagram of an example environment 300 in which systems and/or methods described herein may be implemented. As shown in FIG. 3, the environment 300 may include a scheduling system 301, which may include one or more elements of and/or may execute within a cloud computing system 302. The cloud computing system 302 may include one or more elements 303-313, as described in more detail below. As further shown in FIG. 3, the environment 300 may include a network 320 and/or a user device 330. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of the computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing the computing hardware 303 to start, stop, and/or manage the one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

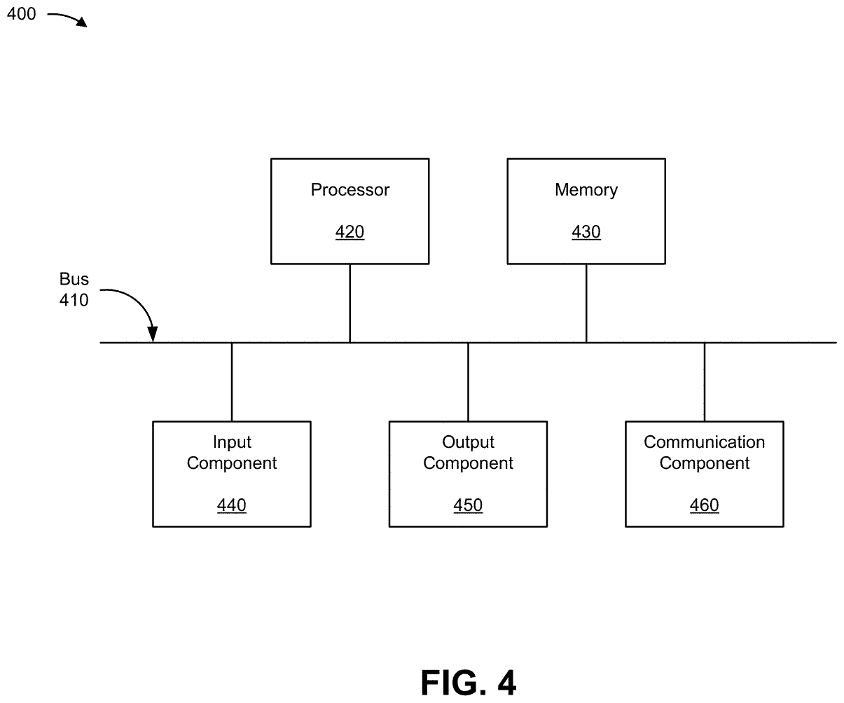

Although the scheduling system 301 may include one or more elements 303-313 of the cloud computing system 302, may execute within the cloud computing system 302, and/or may be hosted within the cloud computing system 302, in some implementations, the scheduling system 301 may not be cloud-based (e.g., may be implemented outside of a cloud computing system) or may be partially cloud-based. For example, the scheduling system 301 may include one or more devices that are not part of the cloud computing system 302, such as device 400 of FIG. 4, which may include a standalone server or another type of computing device. The scheduling system 301 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or the like, and/or a combination of these or other types of networks. The network 320 enables communication among the devices of the environment 300.

The user device 330 includes one or more devices capable of receiving, generating, storing, processing, and/or providing information, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the scheduling system 301 and/or the user device 330. In some implementations, the scheduling system 301 and/or the user device 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes a component that enables wired and/or wireless communication among the components of device 400. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform a function. The memory 430 includes a random-access memory, a read only memory, and/or another type of memory (e.g., a flash memory, a magnetic memory, and/or an optical memory).

The input component 440 enables the device 400 to receive input, such as user input and/or sensed inputs. For example, the input component 440 may include a touch screen, a keyboard, a keypad, a mouse, a button, a microphone, a switch, a sensor, a global positioning system component, an accelerometer, a gyroscope, an actuator, and/or the like. The output component 450 enables the device 400 to provide output, such as via a display, a speaker, and/or one or more light-emitting diodes. The communication component 460 enables the device 400 to communicate with other devices, such as via a wired connection and/or a wireless connection. For example, the communication component 460 may include a receiver, a transmitter, a transceiver, a modem, a network interface card, an antenna, and/or the like.

The device 400 may perform one or more processes described herein. For example, a non-transitory computer-readable medium (e.g., the memory 430) may store a set of instructions (e.g., one or more instructions, code, software code, program code, and/or the like) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

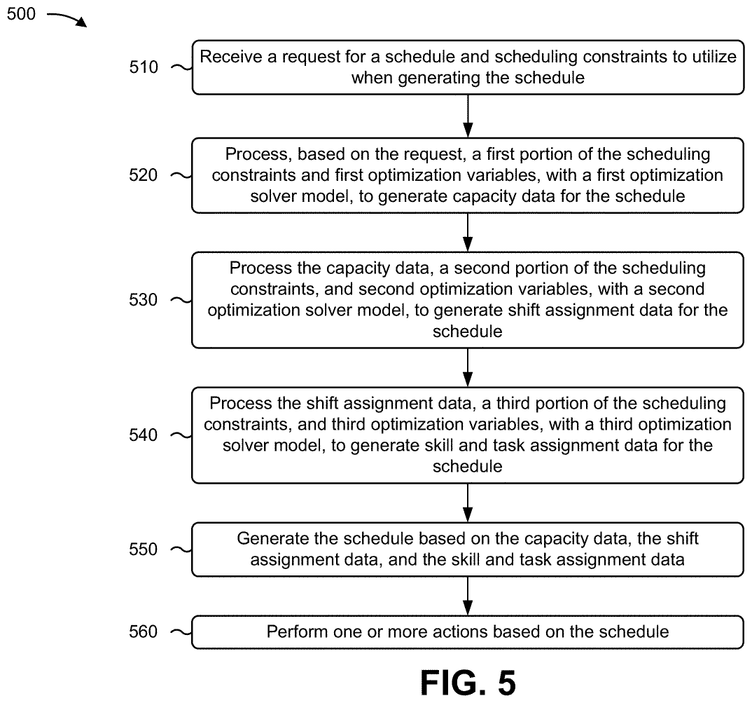

FIG. 5 is a flowchart of an example process 500 for utilizing optimization solver models for sequential automated workforce scheduling. In some implementations, one or more process blocks of FIG. 5 may be performed by a device (e.g., the scheduling system 301). In some implementations, one or more process blocks of FIG. 5 may be performed by another device or a group of devices separate from or including the device, such as a user device (e.g., the user device 330). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving a request for a schedule and scheduling constraints to utilize when generating the schedule (block 510). For example, the device may receive a request for a schedule and scheduling constraints to utilize when generating the schedule, as described above. In some implementations, the scheduling constraints include one or more demand constraints, one or more operation hours constraints, one or more shift timing constraints, one or more days off pattern constraints, one or more schedule rotation constraints, one or more employee roster constraints, or one or more employee restriction constraints.

As further shown in FIG. 5, process 500 may include processing, based on the request, a first portion of the scheduling constraints and first optimization variables, with a first optimization solver model, to generate capacity data for the schedule (block 520). For example, the device may process, based on the request, a first portion of the scheduling constraints and first optimization variables, with a first optimization solver model, to generate capacity data for the schedule, as described above. In some implementations, the first optimization variables include a variable defining an agent working on a skill during a time period, and a variable defining the agent eligible to work on the skill in the time period. In some implementations, the capacity data includes data identifying one or more of capacity requirements as per a demand for the schedule, whether a schedule shift definition is retraining capacity planning for the schedule, or which skills are under the demand or over the demand for the schedule.

As further shown in FIG. 5, process 500 may include processing the capacity data, a second portion of the scheduling constraints, and second optimization variables, with a second optimization solver model, to generate shift assignment data for the schedule (block 530). For example, the device may process the capacity data, a second portion of the scheduling constraints, and second optimization variables, with a second optimization solver model, to generate shift assignment data for the schedule, as described above. In some implementations, the second optimization variables include one or more of a variable defining an agent assigned to a shift, a variable defining a day working in a pattern, a variable defining the agent belonging to the shift, a variable defining a day type for the agent on the day, a variable defining the pattern assigned to the agent, a variable defining the agent assigned to a skillset in the shift on a date, a variable defining the agent assigned a skill in the skillset on the date, a variable defining a quantity of agents in a team assigned to the shift, a variable defining a shortfall on the date in the shift for the skill in the skillset, a variable defining a square of the shortfall, a variable defining a working day for the agent on the day in a historical schedule, or a variable defining the agent assigned to the shift in the historical schedule.

In some implementations, the shift assignment data includes data identifying one or more of issues due to agent restrictions for the schedule, whether vacation days are defined properly for the schedule, or whether vacation date rotations constrain planning for one or more shifts of the schedule.

As further shown in FIG. 5, process 500 may include processing the shift assignment data, a third portion of the scheduling constraints, and third optimization variables, with a third optimization solver model, to generate skill and task assignment data for the schedule (block 540). For example, the device may process the shift assignment data, a third portion of the scheduling constraints, and third optimization variables, with a third optimization solver model, to generate skill and task assignment data for the schedule, as described above. In some implementations, each of the first optimization solver model, the second optimization solver model, and the third optimization solver model is a constraint programming model. In some implementations, the third optimization variables include one or more of a variable defining an agent working with a skill during a time interval, a variable defining the agent working on an activity during the time interval, a variable defining a shortfall in the time interval for the skill, a variable defining whether the agent is on vacation during the time interval, or a variable defining whether the activity is permitted during the time interval. In some implementations, the skill and task assignment data includes data identifying whether breaks are causing a shortfall during one or more time intervals.

As further shown in FIG. 5, process 500 may include generating the schedule based on the capacity data, the shift assignment data, and the skill and task assignment data (block 550). For example, the device may generate the schedule based on the capacity data, the shift assignment data, and the skill and task assignment data, as described above.

As further shown in FIG. 5, process 500 may include performing one or more actions based on the schedule (block 560). For example, the device may perform one or more actions based on the schedule, as described above. In some implementations, performing the one or more actions includes providing the schedule for display, causing the schedule to be approved and deployed, or retraining one or more of the first constraint programming model, the second constraint programming model, or the third constraint programming model based on the schedule.

In some implementations, performing the one or more actions includes providing the schedule for display to a user device, receiving feedback on the schedule from the user device, updating the schedule based on the feedback and to generate an updated schedule, and providing the updated schedule for display. In some implementations, performing the one or more actions includes updating the scheduling constraints to generate updated scheduling constraints, generating an updated schedule based on the updated scheduling constraints, and providing the updated schedule for display.

In some implementations, process 500 includes temporarily allocating one or more first resources for generating the capacity data for the schedule, temporarily allocating one or more second resources for generating the shift assignment data for the schedule, and temporarily allocating one or more third resources for generating the skill and task assignment data for the schedule.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a request for a schedule and scheduling constraints to utilize when generating the schedule;
processing, by the device and based on the request, a first portion of the scheduling constraints and first optimization variables, with a first optimization solver model, to generate capacity data for the schedule;
processing, by the device, the capacity data, a second portion of the scheduling constraints, and second optimization variables, with a second optimization solver model, to generate shift assignment data for the schedule;
processing, by the device, the shift assignment data, a third portion of the scheduling constraints, and third optimization variables, with a third optimization solver model, to generate skill and task assignment data for the schedule;
generating, by the device, the schedule based on the capacity data, the shift assignment data, and the skill and task assignment data; and
performing, by the device, one or more actions based on the schedule.

2. The method of claim 1, wherein the scheduling constraints include one or more of:
one or more demand constraints,
one or more operation hours constraints,
one or more shift timing constraints,
one or more days off pattern constraints,
one or more schedule rotation constraints,
one or more employee roster constraints, or
one or more employee restriction constraints.

3. The method of claim 1, wherein each of the first optimization solver model, the second optimization solver model, and the third optimization solver model is a constraint programming model.

4. The method of claim 1, wherein the first optimization variables include:
a variable defining an agent working on a skill during a time period, and
a variable defining the agent eligible to work on the skill in the time period.

5. The method of claim 1, wherein the capacity data includes data identifying one or more of:
capacity requirements as per a demand for the schedule,
whether a schedule shift definition is retraining capacity planning for the schedule, or
which skills are under the demand or over the demand for the schedule.

6. The method of claim 1, wherein the second optimization variables include one or more of:
a variable defining an agent assigned to a shift,
a variable defining a day working in a pattern,
a variable defining the agent belonging to the shift,
a variable defining a day type for the agent on the day,
a variable defining the pattern assigned to the agent,
a variable defining the agent assigned to a skillset in the shift on a date,
a variable defining the agent assigned a skill in the skillset on the date,
a variable defining a quantity of agents in a team assigned to the shift,
a variable defining a shortfall on the date in the shift for the skill in the skillset,
a variable defining a square of the shortfall,
a variable defining a working day for the agent on the day in a historical schedule, or
a variable defining the agent assigned to the shift in the historical schedule.

7. The method of claim 1, wherein the shift assignment data includes data identifying one or more of:
issues due to agent restrictions for the schedule,
whether vacation days are defined properly for the schedule, or
whether vacation date rotations constrain planning for one or more shifts of the schedule.

8. A device, comprising:
one or more memories; and
one or more processors, coupled to the one or more memories, configured to:
receive a request for a schedule and scheduling constraints to utilize when generating the schedule;
process, based on the request, a first portion of the scheduling constraints and first optimization variables, with a first constraint programming model, to generate capacity data for the schedule;
process the capacity data, a second portion of the scheduling constraints, and second optimization variables, with a second constraint programming model, to generate shift assignment data for the schedule;
process the shift assignment data, a third portion of the scheduling constraints, and third optimization variables, with a third constraint programming model, to generate skill and task assignment data for the schedule;
generate the schedule based on the capacity data, the shift assignment data, and the skill and task assignment data; and
perform one or more actions based on the schedule.

9. The device of claim 8, wherein the third optimization variables include one or more of:
a variable defining an agent working with a skill during a time interval,
a variable defining the agent working on an activity during the time interval,
a variable defining a shortfall in the time interval for the skill,
a variable defining whether the agent is on vacation during the time interval, or
a variable defining whether the activity is permitted during the time interval.

10. The device of claim 8, wherein the skill and task assignment data includes data identifying whether breaks are causing a shortfall during one or more time intervals.

11. The device of claim 8, wherein the one or more processors, to perform the one or more actions, are configured to one or more of:
provide the schedule for display;
cause the schedule to be approved and deployed; or
retrain one or more of the first constraint programming model, the second constraint programming model, or the third constraint programming model based on the schedule.

12. The device of claim 8, wherein the one or more processors, to perform the one or more actions, are configured to:
provide the schedule for display to a user device;
receive feedback on the schedule from the user device;
update the schedule based on the feedback and to generate an updated schedule; and
provide the updated schedule for display.

13. The device of claim 8, wherein the one or more processors, to perform the one or more actions, are configured to:
update the scheduling constraints to generate updated scheduling constraints;
generate an updated schedule based on the updated scheduling constraints; and
provide the updated schedule for display.

14. The device of claim 8, wherein the one or more processors are further configured to:
temporarily allocate one or more first resources for generating the capacity data for the schedule;
temporarily allocate one or more second resources for generating the shift assignment data for the schedule; and
temporarily allocate one or more third resources for generating the skill and task assignment data for the schedule.

15. A non-transitory computer-readable medium storing a set of instructions, the set of instructions comprising:
one or more instructions that, when executed by one or more processors of a device, cause the device to:
receive a request for a schedule and scheduling constraints to utilize when generating the schedule,
wherein the scheduling constraints include one or more of:
demand constraints,
operation hours constraints,
shift timing constraints,
days off pattern constraints,
schedule rotation constraints,
employee roster constraints, or
employee restriction constraints;
process, based on the request, a first portion of the scheduling constraints and first optimization variables, with a first optimization solver model, to generate capacity data for the schedule;
process the capacity data, a second portion of the scheduling constraints, and second optimization variables, with a second optimization solver model, to generate shift assignment data for the schedule;
process the shift assignment data, a third portion of the scheduling constraints, and third optimization variables, with a third optimization solver model, to generate skill and task assignment data for the schedule;
generate the schedule based on the capacity data, the shift assignment data, and the skill and task assignment data; and
perform one or more actions based on the schedule.

16. The non-transitory computer-readable medium of claim 15, wherein the capacity data includes data identifying one or more of:
capacity requirements as per a demand for the schedule,
whether a shift definition is retraining capacity planning for the schedule, or
which skills are under the demand or over the demand for the schedule.

17. The non-transitory computer-readable medium of claim 15, wherein the shift assignment data includes data identifying one or more of:
issues due to agent restrictions for the schedule,
whether vacation days are defined properly for the schedule, or
whether vacation date rotations constrain planning for one or more shifts of the schedule.

18. The non-transitory computer-readable medium of claim 15, wherein the skill and task assignment data includes data identifying whether breaks are causing a shortfall during one or more time intervals.

19. The non-transitory computer-readable medium of claim 15, wherein the one or more instructions, that cause the device to perform the one or more actions, cause the device to one or more of:
provide the schedule for display;
cause the schedule to be approved and deployed; or
retrain one or more of the first optimization solver model, the second optimization solver model, or the third optimization solver model based on the schedule.

20. The non-transitory computer-readable medium of claim 15, wherein the one or more instructions, that cause the device to perform the one or more actions, cause the device to one or more of:
receive feedback on the schedule and generate an updated schedule based on the feedback; or
generate updated scheduling constraints and generate an updated schedule based on the updated scheduling constraints.
